(19) United States
(12) Patent Application Publication
(10) Pub. No.: US 2014/0296393 A1
(43) Pub. Date: Oct. 2, 2014

(54) INKJET INKS CONTAINING PIGMENTED DISPERSIONS WITH IMPROVED WATER REDISPERSABILITY

(71) Applicant: E I DU PONT DE NEMOURS AND COMPANY, Wilmington, DE (US)

(72) Inventors: JOSE ESTEBAN VALENTINI, West Chester, PA (US); Gregory Paul Morris, Horsham, PA (US); Patrick F. McIntyre, West Chester, PA (US); C Chad Roberts, Hockessin, DE (US)

(73) Assignee: E I DU PONT DE NEMOURS AND COMPANY, Wilmington, DE (US)

(21) Appl. No.: 14/225,760

(22) Filed: Mar. 26, 2014

Related U.S. Application Data
(60) Provisional application No. 61/806,453, filed on Mar. 29, 2013.

(51) Int. Cl. C09D 11/00

(52) U.S. Cl. CPC C09D 11/30
USPC 524/56

(57) ABSTRACT

The present disclosure provides an aqueous ink for inkjet printing. The ink contains an aqueous vehicle, a pigment dispersion and a polyacrylate dispersant to disperse the pigment dispersion. The dispersion contains a disaccharide to aid water redispersability.

### CROSS REFERENCE TO RELATED APPLICATIONS

This application claims priority under 35 U.S.C. §119 from U.S. Provisional Application Ser. No. 61/806,453, filed Mar. 29, 2013, which is incorporated by reference in its entirety,

### BACKGROUND OF THE DISCLOSURE

This disclosure pertains to an aqueous inkjet ink, in particular to an aqueous inkjet ink comprising an aqueous vehicle, a pigment dispersion and a polyacrylate dispersant to disperse the pigment dispersion. The dispersion contains a disaccharide to aid water redispersability.

Inkjet printing is anon-impact printing process in which droplets of ink are deposited on a substrate, such as paper, to form the desired image. Inkjet printers are equipped with an ink set which, for full color printing, typically comprises a cyan, magenta and yellow ink (CMY). An ink set also commonly comprises a black ink (CMYK).

Inkjet inks are often prepared from pigment dispersions by diluting with an aqueous vehicle and formulating with other ink additives. Pigment dispersions are obtained by dispersing pigment particles in water with a dispersant having hydrophilic moieties which are soluble in the aqueous phase. The hydrophilic moieties consist of negatively ionized acid groups embedded into a polymer chain or “arms”. The combination of negative charges and the associated water molecules surrounding these acid groups forming “arms” provide steric repulsion between particles and prevent the aggregation of pigment particles. Hence dispersions are stable and particle sizes remain constant. There arc times when concentrating or removing water from pigment dispersions is necessary, such as to reduce space needed for storage or forming a concentrate for transportation. However, as water is removed from a pigment dispersion, the acid groups (the “arms”) on the dispersion collapse with each other and even fold on pigment particles' outer layer which typically is hydrophobic. Upon rehydration, these “arms” are unable to regain their functionality to provide steric repulsion resulting in a poor pigment dispersion with significant particle separation.

Various methods have been studied to improve the water redispersability of pigment dispersions. These methods include making dispersants with high ethylene oxide and/or acid content to improve hydrophilicity and water redispersability, adding hydrophilic solvents to the dispersion, and lowering the glass transition temperature of the dispersant to make the residue more wettable, etc.

A need exists for pigment dispersions with better water redispersability. The present disclosure satisfies this need by providing pigment dispersions having improved water redispersability property.

### SUMMARY OF THE DISCLOSURE

An embodiment provides an ink-jet ink comprising an aqueous vehicle and an aqueous pigment dispersion, wherein said pigment dispersion is comprised of a colorant, a polyacrylate dispersant to disperse said colorant and a disaccharide, wherein said dispersion can be concentrated to having greater than 60% of said colorant by weight based on the weight of the dispersion and rehydrated with water to reconstitute said dispersion.

Another embodiment provides that the dispersion can be concentrated to having greater than 65% of said colorant by weight based on the weight of the dispersion and rehydrated with water to reconstitute said dispersion.

Another embodiment provides that the dispersion can be concentrated to having greater than 70% of said colorant by weight based on the weight of the dispersion and rehydrated with water to reconstitute said dispersion.

Another embodiment provides that the dispersion can be concentrated to having greater than 60% of said colorant by weight based on the weight of the dispersion and rehydrated with water with a growth in particle size of less than 10%.

Another embodiment provides that the polyacrylate dispersant is a polymer containing an aqueous dispersing moiety and a cross-linkable moiety that is cross-linked with a cross-linking agent.

Another embodiment provides that the aqueous dispersing moiety is a carboxyl group.

Another embodiment provides that the cross-linkable moiety moiety is a carboxyl group.

Another embodiment provides that the cross-linking agent is one or more members selected from the group consisting of epoxide, isocyanate, carbodiimide, N-methylol, oxazoline, silane, and mixtures thereof.

Another embodiment provides that the cross-linking agent is epoxide.

Yet another embodiment provides that the disaccharide is trehalose.

These and other features and advantages of the present embodiments will be more readily understood by those of ordinary skill in the art from a reading of the following Detailed Description. Certain features of the disclosed embodiments which are, for clarity, described above and below as separate embodiments, may also be provided in combination in a single embodiment. Conversely, various features of the disclosed embodiments that are described in the context of a single embodiment, may also be provided separately or in any subcombination.

### DETAILED DESCRIPTION

Unless otherwise stated or defined, all technical and scientific terms used herein have commonly understood meanings by one of ordinary skill in the art to which this disclosure pertains.

Unless stated otherwise, all percentages, parts, ratios, etc., are by weight.

When an amount, concentration, or other value or parameter is given as either a range, preferred range or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range.

When the term “about” is used in describing a value or an end-point of a range, the disclosure should be understood to include the specific value or end-point referred to.

As used herein, the term “dispersion” means a two phase system wherein one phase consists of finely divided particles (often in a colloidal size range) distributed throughout a bulk substance, the particles being the dispersed or internal phase and the bulk substance being the continuous or external phase.

As used herein, the term “dispersant” means a surface active agent added to a suspending medium to promote uniform and maximum separation of extremely fine solid particles often of colloidal sizes. For pigments, the dispersants are most often polymeric dispersants, and the dispersants and pigments are usually combined using a dispersing equipment.

As used herein, the term “OD” means optic density.

As used herein, the term “aqueous vehicle” refers to water or a mixture of water and at least one water-soluble, or partially water-soluble (i.e., methyl ethyl ketone), organic solvent (co-solvent).

As used herein, the term “substantially” means being of considerable degree, almost all.

As used herein, the term “dyne/cm” means dyne per centimetre, a surface tension unit.

As used herein, the term “cP” means centipoise, a viscosity unit.

As used herein, the term “mPa·s” means millipascal second, a viscosity unit.

As used herein, the term “mN.m⁻¹” means milliNewtons per meter, a surface tension unit.

As used herein, the term “mS.cm⁻¹” means milliSiemens per centimeter, a conductivity unit.

As used herein, the term “EDTA” means ethylenediaminetetraacetic acid.

As used herein, the term “IDA” means iminodiacetic acid.

As used herein, the term “EDDHA” means ethylenediamine-di(o-hydroxyphenylacetic acid).

As used herein, the term “DHEG” means dihydroxyethylglycine.

As used herein, the term “DTPA” means diethylenetriamine-N,N,N′,N″,N″-pentaacetic acid.

As used herein, the term “GEDTA” means glycoletherdiamine-N,N,N′,N′-tetraacetic acid.

As used herein, the term “TRIZMA” means 2-Amino-2-(hydroxymethyl)-1,3-propanediol, a reagent supplied by Sigma-Aldrich, Saint Louis, Mo., USA.

As used herein, the term “BzMA” means benzyl methacrylate.

As used herein, the term “MAA” means methyl acrylic acid.

As used herein, the term “ETEGMA” means ethoxytriethyleneglycol methacrylate.

As used herein, the term “jettability” means good jetting properties with no clogging or deflection during printing.

Unless otherwise noted, the above chemicals were obtained from Aldrich (Milwaukee, Wis., U.S.A. or other similar suppliers of laboratory chemicals.

The materials, methods, and examples herein are illustrative only except as explicitly stated, and are not intended to be limiting.

### Aqueous Vehicle

Selection of a suitable aqueous vehicle mixture depends on requirements of the specific application, such as the desired surface tension and viscosity, the selected colorant, drying time of the ink, and the type of substrate onto which the ink will be printed. Representative examples of water-soluble organic solvents which may be utilized in the present disclosure are those that are disclosed in U.S. Pat. No. 5,085,698.

If a mixture of water and a water-soluble solvent is used, the aqueous vehicle typically will contain about 30% to about 95% of water with the remaining balance (i.e., about 70% to about 5%) being the water-soluble solvent. Compositions of the present disclosure may contain about 60% to about 95% water, based on the total weight of the aqueous vehicle.

The amount of aqueous vehicle in the ink is typically in the range of about 70% to about 99.8%; specifically about 80% to about 99.8%, based on total weight of the ink.

The aqueous vehicle can be made to be fast penetrating (rapid drying) by including surfactants or penetrating agents such as glycol ether(s) or 1,2-alkanediols. Suitable surfactants include ethoxylated acetylene diols (e.g., Surfynols® series from Air Products), ethoxylated primary (e,g., Neodol® series from Shell) and secondary (e.g., Tergitol® series from Union Carbide) alcohols, sulfosuecinates (e.g. Aerosol® series from Cytec), organosilicones (e.g., Silwet® series from Witco) and fluoro surfactants (e.g., Zonyl® series from DuPont).

The amount of glycol ether(s) or 1,2-alkanediol(s) added must be properly determined, but is typically in a range of from about 1% to about 15% by weight, and more typically about 2% to about 10% by weight, based on the total weight of the ink. Surfactants may be used, typically in an amount of from about 0.01% to about 5%, and specifically from about 0.2% to about 2%, based on the total weizht of the ink.

### Pigments

The term “pigment” as used herein means an insoluble colorant that requires to be dispersed with a dispersant and processed under dispersive conditions in the presence of a dispersant. The colorant also includes dispersed dyes. The dispersion process results in a stable dispersed pigment,

The selected pigment(s) may be used in dry or wet form. For example, pigments are usually manufactured in aqueous media, and the resulting pigments are obtained as a water-wet presscake. In presscake form, the pigment does not agglomerate to the extent it would in dry form. Thus, pigments in water-wet presscake form do not require as much mixing energy to de-agglomerate in the premix process as pigments in dry form. Representative commercial dry pigments are listed in U.S. Pat. No. 5,085,698.

Some examples of pigments with coloristic properties useful in inkjet inks include: cyan pigments from Pigment Blue 15:3 and Pigment Blue 15:4; magenta pigments from Pigment Red 122 and Pigment Red 202; yellow pigments from Pigment Yellow 14, Pigment Yellow 95, Pigment Yellow 110, Pigment Yellow 114, Pigment Yellow 128 and Pigment Yellow 155; red pigments from Pigment Orange 5, Pigment Orange 34, Pigment Orange 43, Pigment Orange 62, Pigment Red 17, Pigment Red 49:2, Pigment Red 112, Pigment Red 149, Pigment Red 177, Pigment Red 178, Pigment Red 188, Pigment Red 255 and Pigment Red 264; green pigments from Pigment Green 1, Pigment Green 2, Pigment Green 7 and Pigment Green 36; blue pigments from Pigment Blue 60, Pigment Violet 3, Pigment Violet 19, Pigment ⁻Violet 23, Pigment Violet 32, Pigment Violet 36 and Pigment Violet 38; white pigments such as TiO₂ and ZnO; and black pigment carbon black. The pigment names and abbreviations used herein are the “C.I.” designation for pigments established by Society of Dyers and Colourists, Bradford, Yorkshire, UK and published in The Color Index, Third Edition, 1971.

The range of useful particle size after dispersion is typically from about 0.005 micrometers to about 15 micrometers. Typically, the pigment particle size should range from about 0.005 micrometers to about 5 micrometers; and, specifically, from about 0.005 micrometers to about 1 micrometers. The average particle size as measured by dynamic light scattering is less than about 500 nm, typically less than about 300 nm.

The amount of pigment present in the ink is typically in the range of from about 0.1% to about 25% by weight, and more typically in the range of from about 0.5% to about 10% by weight, based on the total weight of ink. If an inorganic pigment is selected, the ink will tend to contain higher percentages by weight of pigment than with comparable inks employing organic pigment, since inorganic pigments generally have higher densities than organic pigments.

### Disaccharide Additive

The inventors find that the rater redispersability of pigment dispersions can be improved by having a highly water soluble additive capable of both a) replacing the depleted water as drying occurs to prevent separation of acid groups, and b) forming a solid film between dry particles. Disaccharide is a desirable additive for this purpose, since it can form a thin film as drying of a dispersion occurs. The film surrounds the dispersed particles in a glassy state at a temperature that is close to the drying temperature. The film prevents collapsing of acid moieties of a dispersant during drying and thus prevents aggregation of pigment particles. Upon rehydration, the additive redissolves the film, and hydrophilic moieties which were in a “frozen” dry state recover their original functionality reconstituting the original pigment dispersion. Many commercially available disaccharide are suitable to improve the redispersability of a pigment dispersion. Particularly suitable is trehalose.

The disaccharide additive is included in the dispersion in an effective amount to improve water redispersability of pigment dispersion relative to the same pigment dispersion without the disaccharide additive. Typically, the disaccharide additive is present in a dispersion at a level of at least about 0.2 by weight based on the total weight of the dispersion. The upper level is not limited, but is dictated by considerations such as compatibility with other dispersion components. In one embodiment, the disaccharide additive is present in a range of 0.1% to 20 % based on the total weight of the dispersion, In another embodiment, the disaccharide additive is present in a range of 0.2% to 5% based on the total weight of the dispersion. The appropriate levels of disaccharide additive can be readily determined by one of ordinary skill in the art through routine experimentation.

### Polyacrylate Dispersant

The polyacrylate dispersant may be a random or a structured polymer. Typically, the polymer dispersant is a copolymer of hydrophobic and hydrophilic monomers. The “random polymer” means polymers where molecules of each monomer are randomly arranged in the polymer backbone. For a reference on suitable random polymeric dispersants, see: U.S. Pat. No. 4,597,794. The “structured polymer” means polymers having a block, branched, graft or star structure. Examples of structured polymers include AB or BAB block copolymers such as the ones disclosed in U.S. Pat. No. 5,085,698; ABC block copolymers such as the ones disclosed in EP Patent Specification No. 0556649; and graft polymers such as the ones disclosed in U.S. Pat. No. 5,231,131. Other polymeric dispersants that can be used are described, for example, in U.S. Pat. No. 6,117,921, U.S. Pat. No. 6,262,152, U.S. Pat. No. 6,306,994 and U.S. Pat. No. 6,433,117.

### Structured Vinyl Polymeric Dispersant

The function of the polymeric dispersant is to disperse the solid particle, more typically a colorant, in the aqueous ink vehicle. Structured polymeric dispersants are particularly preferred. The term “structured polymer” means any polymer that does not have a random structure. Stated differently, the term “structured polymer” means that the polymer has identifiable and defined segments or areas based on the type, identity and/or behavior of the monomers contained within the segment or area. Typically, but not always, those segments are characterized as being hydrophobic or hydrophilic.

Examples of structured polymers include block polymers, graft polymers, tapered polymers and branch polymers. Particularly typical structured polymeric dispersants for use in the present disclosure are block and graft copolymers. Structured polymeric dispersants are particularly useful because it is easier to produce segments having the desired functionality in such polymers versus random polymers. Graft polymers having an insoluble backbone and soluble arms are particularly typical. Such polymers can be prepared by techniques well known in the art. For example, block polymers can be made using the well known Group Transfer Polymerization technique and graft polymers my be prepared using chain transfer agents. Specific conditions for preparing particularly typical polymers are set forth in the examples.

Regardless of the structure of the polymeric dispersant, the polymeric dispersant typically contains one or more segments that are soluble in the aqueous ink vehicle (hydrophilic segment) and one or more segments that are insoluble in the aqueous ink vehicle (hydrophobic segment). As such, the polymer has an area or segment that has an affinity for the aqueous ink vehicle and an area or segment that has an aversion for the aqueous ink vehicle. When the polymer is placed into the liquid, it will naturally tend to orient itself such that the segment(s) with aversion to the liquid will cluster together to form a liquid adverse “core” and the segment(s) with affinity for the vehicle are aligned away from the core. The particles, which are insoluble and thus also have an aversion for the liquid, tend to migrate into the “core” formed by the polymer alignment. Generally speaking, the solid particle is relatively content to stay isolated in this liquid free “core”. Under certain conditions, however, such as changes in temperature, changes in composition of the aqueous ink vehicle, etc. the solid particles tend to move out of the core where they can flocculate and precipitate. The present disclosure addresses this problem by cross-linking the soluble polymer segment to form a network or matrix around the solid particle which is extremely resistant to changes in aqueous ink vehicle composition, temperature and other factors known to destabilize dispersions. The solid particle is entrapped in a network formed by the soluble polymer segment and the cross-linking bonds. The cross-linking bonds are very stable and effectively prevent the solid particle from leaving the “core” formed by the polymer. The soluble segment of the polymer remains aligned into the aqueous ink vehicle and away from the liquid adverse “core”. It is not necessary that the solid particle be covalently bonded to the polymer dispersant to obtain the improved dispersion stability. However, it is understood that the dispersions of the present disclosure do not preclude situations where the solid particle, in addition to being entrapped in the cross-linked matrix, would also be covalently bonded to the polymer.

The soluble segment will contain hydrophilic monomers and the insoluble segment will contain hydrophobic monomers. It is also possible to introduce solubility by making a salt of the monomers used in the soluble segment, particularly for aqueous dispersions, as is known in the art. Whatever the precise composition of the soluble segment may be, it is important that this segment be such that the entire polymer dispersant (or a salt thereof) is soluble or dispersible in the aqueous ink vehicle.

Hydrophobic and hydrophilic monomers are well known o those skilled in the art. Particularly useful hydrophobic monomers include:
1) C₁₋₁₂ alkyl, C₆₋₁₂ aryl, and C₁₋₁₂ alkyl-C₆₋₁₂ aryl acrylates or methacrylates such as methyl, ethyl, butyl, propyl, isobutyl, hexyl 2-ethyl hexyl, nonyl, lauryl, isobornyl, benzyl acrylates and methacrylates and the like;
2) polymerizable vinyl aromatic monomers such as styrene, alpha methyl styrene, vinyl toluene and the like; and
3) aliphatic hydrocarbon monomers such as isoprene and butadiene.

Particularly useful hydrophilic monomers (i.e., those which can impart water-solubility) include: (1) acid monomers such as acrylic acid, methacrylic acid, acrylamidomehylpropane sulfonic acid, itaconic acid, maleic acid and styrene sulfonic acid; (2) amine-containing monomers such as 2-dimethylaminoethyl methacrylate, 2-dimethylaminoethyl acrylate, 2-diethylaminoethyl methacrylate, and 2-diethylaminoethyl acrylate; and (3) monomers having oligoether moieties of the Formula (I)

CH₂═CRC(O)O(CH₂CH₂O)ₙR₁ Formula (I) n

wherein R═H or methyl; R₁═C₁₋₄ alkyl, aryl C₆₋₁₂, or C₁₋₁₂ alkyl-C₆₋₁₂aryl, and n=1 to 20, examples of which include ethoxyethyl methacrylate, butoxyethyl methacrylate, ethoxytriethylene methacrylate, methoxypolyethylene glycol methacrylate, and 2-ethoxytriethylene glycol methacrylate.

It may be necessary to neutralize the monomers to make them soluble. Suitable reagents to neutralize the acid monomers include mono-, di-, tri-methylamine, morpholine, n-methyl morpholine; alcohol amines such as dimethylethanolamine (DMEA), methyldiethanolamine, mono-, di-, and tri-ethanolamine; pyridine; ammonium hydroxide; tetra-alkylammonium salts such as tetramethylammonium hydroxide, tetraethyl-ammonium hydroxide; alkali metals hydroxides such as lithium, sodium and potassium hydroxide, aminopropanol, and the like. The amine monomers may be neutralized with inorganic and organic acid such as acetic acid, formic acid, oxalic acid, dimethylol propionic acid, hydrochloric acid, p-toluene sulfonic acid, benzene sulfonic acid, nitric acid, citric acid, and the like; halogens such as chloride, fluoride, and bromide, and inorganic acids, such as sulfuric acid, nitric acid, phosphoric acid and the like. It is also possible to convert the amino group into a tetra-alkyl ammonium salt. Alternately, the amine functionalities can be rendered water-soluble by quaternization with reagents such as benzyl chloride, dimethylsulfate, methyl chloride, etc.

Depending on the number, n, of oxyethylene units in the monomers containing oligoether moieties, the polymer can be slightly or completely water soluble. The solubility of the polymer increases as the number of oxyethylene units increases. The monomers having oligoether moieties can be advantageously used to adjust the physical properties, such as Tg, of the polymer dispersant.

### Crosslinked Polymeric Dispersant

The polymeric dispersants have crosslinkable functional moieties in the soluble segment that is the hydrophilic segment. The soluble segment(s) of the dispersant is thus capable of cross-linking to an additional cross-linking compound monomer, oligomer, or polymer) that has suitable cross-linking functionality. The dispersant is thus capable of crosslinking to a crosslinking agent that has crosslinking functionality reactive with the crosslinkable moieties. Useful cross-linking compounds are those which are insoluble in the aqueous ink vehicle and which do not have significant reaction with the aqueous ink vehicle. Typically, the crosslinking of the structured vinyl polymeric dispersant occurs after the solid particle is dispersed in the structured vinyl polymeric dispersant to form an aqueous dispersion. Mole ratio of the crosslinkable moiety on the polymer chain and crosslinking functional groups on the crosslinking agent can be from about 10:1 to about 1:1.5, typically from about 9:1 to about 1:1.1, most typically from about 8:1 to about 1:1.

The list below identifies some suitable crosslinkable moieties that may be operated into the soluble segment of the polymeric dispersant and the companion crosslinking functional groups that may be present in the crosslinking agent.

| Crosslinkable moieties | Crosslinking functional group |
|---|---|
| Acid, —COOH | Epoxide, carbodiimide, oxazoline |
| Hydroxyl, —OH | Epoxide, silane, isocyanate |
| Amino, —NH₂ or NHR | Epoxide, silane, isocyanate, |
| | Carbodiimide |

As noted above, the functional moieties can be incorporated into the soluble segment of the polymeric dispersant by selection of appropriate monomers. Additionally, mixtures of these crosslinking moieties may also be present throughout the polymeric dispersant. A separate crosslinking agent having the appropriate group can be added to the dispersion to crosslink the polymeric dispersant. Useful crosslinking agents are those which are typically insoluble in the aqueous ink vehicle, including m-tetramethylxylene diisocyanate (TMXDI), isophorone diisocyanate (IPDI), trimethylopropane polyglycidyl ether, water-insoluble epoxide resin, oxazoline-functional polymers, polycarbodiimide resin, and silane. After the completion of the crosslinking, pH of the crosslinked dispersion can be adjusted to at least about 8.0, more typically about 8.0 to 12.0, and most typically about 8.0 to about 11.0.

### Preparation of Particle Dispersion and Crosslinking of the Dispersants

The aqueous dispersions of the present disclosure may be prepared using any conventional milling process known in the art. Most milling processes use a two-step process involving a first mixing step followed by a second grinding step. The first step comprises the mixing of all the ingredients, i.e., particle, dispersant(s), liquid carrier(s), pH adjuster and any optional additives, to provide a blended “premix”. Typically all liquid ingredients are added first, followed by the dispersant(s) and lastly the particle. Mixing is generally done in a stirred mixing vessel and High Speed Dispersers, (HSD), are particularly suitable for the mixing step. A Cowels type blade attached to the HSD and operated at 500 rpm to 4000 rpm, and typically 2000 rpm to 3500 rpm, provides optimal shear to achieve desired mixing. Adequate mixing is usually achieved by mixing for about 15 minutes to about 120 minutes.

The second step comprises milling of the premix to produce a stable aqueous dispersion. A typical milling process for carbon black pigments that avoids media contamination is the Microfluidizer Process, although other milling techniques can be used. In a specific embodiment, a lab scale model M-110Y High Pressure Pneumatic, Microfluidizer with a diamond Z-Chamber from Microfluidics of Newton, Mass. can be used. The Microfluidizer uses an impingement process at h pressures to deagglomerate and mill fine particles, such as pigments. The model M-110Y Microfluidizer can operate at pressure ranges of about 3,000 to about 23,000 psi, although pressures of about 10,000 to about 15,000 are typical. The flow rates through the microfluidizer were typically about 200 to about 500 mL/min. and more typically about 300 to about 450 mL/min.

The second step milling process for color pigment typically involves a media milling process, although other milling techniques can also be used. In the present invention, a lab-scale Eiger Minimill (Model M250, VSE EXP) manufactured by Eiger Machinery Inc., Chicago, Ill. is employed. Grinding was accomplished by charging 0.5 mm YTZ® zirconia media to the mill. The mill disk is operated at a speed between 2000 rpm and 4000 rpm, and typically between 3000 rpm and 3500 rpm. The dispersion is processed using a re-circulation grinding process with a typical flow rate through the mill at between 200 to 500 grams/minute, and more typically at 300 grams/minute.

The milling can be done using a staged procedure in which a fraction of the solvent may be held out of the grind and added after milling is completed. This amount of solvent held out during milling can vary by dispersion and is typically about 100 to about 300 grams of the total 600 gram batch size. This can be done to achieve optimal rheology and viscosity for grinding efficiency. Each dispersion can be processed for a total of 10 passes through the mill although the endpoint can be achieved in less milling time.

Aqueous pigmented dispersions can be prepared using the pigments identified earlier. The premix can be prepared at typically 23% pigment loading and the dispersant level was set at a P/D (pigment/dispersant), most typically at a P/D of 2.5. A P/D of 2.5 corresponds to a 40% dispersant level on pigment. The structured vinyl polymeric dispersants can typically be neutralized with either alkali metal hydroxide such as LiOH, KOH, NaOH, or amine to facilitate solubility and dissolution into water. Range of neutralization can vary from 30 mole % to 100 mole % based on the mole of ionizable groups on the dispersant resin. The neutralization process can be done either in situ during the premix stage or by pre-neutralizing the resin during the final stage of manufacture.

During the premix stage the pigment level can be maintained at about 18% about 30%, more typically about 23%, and was reduced to about 12% to about 18%, more typically about 15% during the milling stage by adding deionized water for optimal milling conditions. After completing the milling process, the aqueous dispersions can be reduced to about 10% pigment concentration by adding the de-ionized water. Optionally, the aqueous dispersion can be further processed using conventional filtration procedures known in the art. The dispersions can be processed using ultrafiltration techniques to remove co-solvent(s) and other contaminants, ions or impurities from the dispersion. Dispersant crosslinking can then take place by adding the crosslinking agent to the aqueous dispersion comprising the dispersed solid particle. Thorough mixing at room temperature or elevated temperature for several hours is often required to achieve the crosslinking. To facilitate the crosslinking reaction, it may be desirable to add a catalyst and/or to elevate the temperature of the mixture. Useful catalysts can be those that are either soluble or insoluble in the liquid and can be selected depending upon the crosslinking reactions. Some suitable catalysts include dibutyltin dilaurate (DBTDL), tributyl amine (“TBA”) and dimethyldodecyl amine. After completion of the crosslinking, pH of the crosslinked dispersion can be adjusted to at least about 8.0, more typically about 8.0 to 12.0, and most typically about 8.0 to about 11.0, if needed. The treated dispersion can then be filtered through a filter, for example, a 0.3 micron Chipwich filter, available from Pall Trincor of East Falls, NY, to remove any possible contaminants and filled into a polyethylene container. Optionally, the crosslinked dispersion can be processed using ultrafiltration techniques to remove co-solvent(s) and other contaminants, ions or impurities from the dispersion. Each dispersion can be then tested for pH, conductivity, viscosity and particle size.

### Other Additives

Other ingredients, additives, may be formulated into the inkjet ink, to the extent that such other ingredients do not interfere with the stability and jettability of the inkjet ink. This may be readily determined by routine experimentation by one skilled in the art.

Surfactants are commonly added to inks to adjust surface tension and wetting properties. Suitable surfactants include the ones disclosed in the Vehicle section above. Surfactants are typically used in amounts up to about 5% and more typically in amounts up to 2% by weight, based on the total weight of the ink.

Inclusion of sequestering (or chelating) agents such as ethylenediaminetetraacetic acid (EDTA), iminodiacetic acid (IDA), ethylenediamine-di(o-hydroxyphenylacetic acid) (EDDHA), nitrilotriacetic acid (NTA), dihydroxyethylglycine (DHEG), trans-1,2-cyclobexanediaminetetraacetic acid (CyDTA), diethylenetriamine-N,N,N′,N″,N″-pentaacetic acid (DTPA), and glycoletherdiamine-N,N,N′,N′-tetraacetic acid (GEDTA), and salts thereof, may be advantageous, for example, to eliminate deleterious effects of heavy metal impurities.

Polymers may be added to the ink to improve durability or other properties. The polymers can be soluble in the vehicle or in a dispersed form, and can be ionic or nonionic. Soluble polymers include linear homopolymers and copolymers or block polymers. They also can be structured polymers including graft or branched polymers, stars and dendrimers. The dispersed polymers may include, for example, latexes and hydrosols. The polymers may be made by any known process including, but not limited to, free radical, group transfer, ionic, condensation and other types of polymerization. They may be made by a solution, emulsion, or suspension polymerization process. Typical classes of polymer additives include anionic acrylic, styrene-acrylic and polyurethane polymer.

When a polymer is present, its level is typically between about 0.01% and about 3% by weight, based on the total weight of an ink. The upper limit is dictated by ink viscosity or other physical limitations.

### Ink Sets

The term “ink set” refers to all the individual inks or other fluids an inkjet printer is equipped to jet. Ink sets typically comprise at least three differently colored inks. For example, a cyan (C), magenta (M) and yellow (Y) ink forms a CMY ink set. More typically, an ink set includes at least four differently colored inks, for example, by adding a black (K) ink to the CMY ink set to form a CMYK ink set. The magenta, yellow and cyan inks of the ink set are typically aqueous inks, and may contain dyes, pigments or combinations thereof as the colorant. Such other inks are, in a general sense, well known to those of ordinary skill in the art.

In addition to the typical CMYK inks, an ink set may further comprise one or more “gamut-expanding” inks, including differently colored inks such as an orange ink, a green ink, a red ink and/or a blue ink, and combinations of full strength and light strength inks such as light cyan and light magenta. Such other inks are, in a general sense, known to one skilled in the art.

A typical ink set comprises a magenta, yellow, cyan and black ink, wherein the black ink is an ink according to the present disclosure comprising an aqueous vehicle and a self-dispersing carbon black pigment. Specifically, the colorant in each of the magenta, yellow and cyan inks is a dye.

### Ink Properties

Jet velocity, separation length of the droplets, drop size and stream stability are greatly affected by the surface tension and the viscosity of the ink. Pigmented ink jet inks typically have a surface tension in the range of about 20 dyne/cm to about 70 dyne/cm at 25° C. Viscosity can be as high as 30 cP at 25° C., but is typically somewhat lower. The ink has physical properties compatible with a wide range of ejecting conditions, i.e., driving frequency of the piezo element or ejection conditions for a thermal head for either a drop-on-demand device or a continuous device, and the shape and size of the nozzle. The inks should have excellent storage stability for long periods so as not to clog to a significant extent in an ink jet apparatus. Furthermore, the ink should not corrode parts of the ink jet printing device it comes in contact with, and it should be essentially odorless and non-toxic.

Although not restricted to any particular viscosity range or printhead, the inventive ink set is particularly suited to lower viscosity applications such as those required by thermal printheads. Thus the viscosity of the inventive inks at 25° C. can be less than about 7 cP, typically less than about 5 cP, and more typically than about 3.5 cP. Thermal inkjet actuators rely on instantaneous heating/bubble formation to eject ink drops and this mechanism of drop formation generally requires inks of lower viscosity.

### Substrate

The present embodiments are particularly advantageous for printing on plain paper, such as common electrophotographic copier paper and photo paper, glossy paper and similar papers used in inkjet printers.

### EXAMPLES

Inks were prepared by stirring the indicated ingredients together a id filtering the resulting mixture. The water used in the following Examples was deionized unless otherwise stated.

Polymeric Dispersant I has a composition of 13BzMA//13MAA/7.5 ETEGMA, and was prepared by established method as described, for example, in U.S. Pat. No. 5,085,698, the disclosure of which is incorporated by reference herein as if fully set forth. Polymeric Dispersant 2 has a composition of 4MAA//30BzMA//11MAA, and was prepared by established methods as described, for example, in U.S. Pat. No. 5,852,075, the disclosure of which is incorporated by reference herein as if fully set forth.

### Pigment Dispersion 1 (Magenta)

Pigment Dispersion 1 was made using a media milling process using a 1.5 L Supermill supplied by Premier Mill, Inc., Reading, Pa. The first step comprised the mixing of all the ingredients, that is, pigment, dispersants, KOH or other pH adjuster, water and optional cosolvent to provide a blended “premix”. All liquid ingredients were added first, followed by KOH solution what was used to neutralize “in situ” the dispersant, and lastly the pigment. Mixing was done in an appropriately sized, jacketed stainless steel pot. A Cowels type blade attached to an HSD (High Speed Disperser) was operated at 3000 rpm for a total mixing time of 2 hrs.

The pigment loading in the premix step was 25% which was used because it gave optimal rheology for mixing and grinding in the premix step. The amount of KOH neutralizing agent corresponded to 75% neutralization of the active acid groups on the dispersant polymer. This level accommodates approximately 25% of the remaining acid groups on the dispersant for further reaction in the crosslinking stage.

| Ingredients | Amount (g) |
|---|---|
| Deionized Water | 1212.08 |
| Dispersant 1 | 639.65 |
| KOH solution (45.4% active) | 80.27 |
| Pigment (PR 122, Clariant Inkjet EO2 Magenta) | 644.00 |

After the Premix stage was completed, an additional amount of DI eater (224.00 g) was added to reduce the % Pigment loading to 23% which gave the desired viscosity for the next processing step which was the media milling stage.

Next the media milling or dispersing step was performed by charging 1190 ml of 0.5 mm YTZ zirconia media to the 1.5 L Supermill which corresponds to 85% loading. The dispersion was processed for a total of 14 Passes through the mill in which the mill disk speed was nominally 2400 ft/min and the flowrate of the dispersion through the mill was typically, 150 to 200 ml per minute. The milling was done using a staged procedure in which approximately 20% of the DI water was held out of the batch during the grind and was added during the 14^{th}, or last pass, through the mill. After completion of the milling step, a final portion of DI water (1836.80 g) was added with mixing to reduce the pigment loading in the dispersion to 12.5%.

To further improve the dispersion for inkjet applications, the pigment dispersion was filtered through a 0.3 micron Chipwich filter available from Pall Trincor of East Falls, NY. After filtration was completed the batch was filled into 2000 ml polyethylene containers. The total batch size is 5152 grams at 12.5% pigment loading.

Prior to performing the crosslinking reaction, an ultrafiltration step was employed. The ultrafiltration process was conducted using a multi-step procedure in which the entire dispersion is passed through a UF filter which was selected to remove impurities and reduce levels of free polymer in the dispersion. The dispersion was process for a total of 5 passes resulting in a final pigment concentration of 13.09%.

### Epoxy Crosslinking of Dispersion 1 (XL-Dispersion 1, Magenta)

A 3 L round bottom reactor was loaded with 1980.8 g of Pigment Dispersion 1 (13.09% pigment, Clariant E-02 PR122 magenta dispersed with Dispersant 1, at PD 2) and 900.16 g de-ionized water. After mixing the diluted pigment dispersion for several minutes, 8.97 g Denacol 321 epoxy was added, and then the reaction mixture was heated to 80° C. for a total of 6 h. During this time, the acid number decreased from 1.099 to 0.319 mg KOH/g, and pH increased from 7.87 to 8.16. The final dispersion has a surface tension and viscosity of 65.42 dynes/cm and 5.15 cP, respectively, with total solids of 13.44%.

### Pigment Dispersion 2 (Cyan)

Pigment dispersion 2 was prepared by a process similar to the 1.5 L Supermill process described for Pigment dispersion 1 with the following exception: Pigment Cyan, PB 15-3, Dainichiseika TRB-2 was dispersed with Dispersant 1, at a P/D or 2.5. The following table shows the physical property results for Pigment Dispersion 2 (Cyan) with Trehelose. The Pigment dispersion 2 was processed for a total of 12 passes through the 1.5 L Supermill versus the 14 passes of pigment dispersion 1.

### Epoxy Crosslinking of Dispersion 2 (XL-Dispersion 2, Cyan)

A 3 L round bottom reactor was loaded with 2350 g Pigment Dispersion 2, (9.52% pigment, Dainichiseka TRB-2 E-02 dispersed with Dispersant 1, at P/D 2) and 135.78 g de-ionized water. After mixing the diluted pigment dispersion for several minutes, 7.04 g Denacol 321 epoxy was added, and then the reaction mixture was heated to 80° C. for a total of 6 h. During this time, the acid number decreased from 1.512 to 0.880 mg KOH/g, and pH increased from 7.62 to 7.75. The final dispersion has a surface tension and viscosity of 64.435 dynes/cm and 3.40 cP, respectively, with total solids of 13.26%.

### Pigment Dispersion 3 (Yellow)

Pigment dispersion 3 was prepared by a process similar to the 1.5 L Supermill process described for Pigment dispersion 1 with the following exception: Pigment Yellow, PY-74, Sunbrite Yellow 272-5147 from Sun Chemical was dispersed with Dispersant 2, at a P/D or 2.67 and with Dispersant 3, EFKA 4585 from BASE at a P/D of 6.0. Similar to Pigment Dispersion 2, Pigment Dispersion 3 was also processed for 12 passes through the 1.5 L Supermill.

### Epoxy Crosslinking of Dispersion 3 (XL-Dispersion 3, Yellow)

A 1 L round bottom reactor was loaded with 500 g of Dispersion 3 (11.19% pigment, Sunbrite Yellow 74, 272-5147 dispersed with Dispersant 2 at P/D 2) and 121.67 g de-ionized water. After mixing the diluted pigment dispersion for several minutes, 1.50 Denacol 321 epoxy was added, and then the reaction mixture was heated to 80° C. for a total of 6 h. During this time, the acid number decreased from 2.855 to 1.155 mg KOH/g, and pH increased from 7.62 to 8.12. The final dispersion has a surface tension and viscosity of 53.58 dynes/cm and 2,02 cP, respectively, with total solids of 12.81%.

### Comparative Dispersion 1 (Yellow Sucrose)

Comparative Pigment Dispersion 1 (Yellow)) was prepared by the 1.5 L Supermill process described for Pigment dispersion 3 with the exception that Sucrose was used in place of Trehelose. Comparative Dispersion 1 was made using Pigment Yellow, PY-74, Sunbrite Yellow 272-5147 from Sun Chemical was dispersed with Dispersant 2, at a P/D or 2.67 and with Dispersant 3, EFKA 4585 from BASF at a P/D of 6.0. Similar to Pigment Dispersion 3, Comparative Dispersion 1 was made using the same Stage 1 dispersion that was processed for 12 passes through the 1.5 L Supermill. The only difference between Dispersion Example 3 and Comparative Dispersion 1 is Sucrose was used instead of Trehalose as the additive for facilitating redispersiblility.

### Epoxy Crosslinking of Comparative Dispersion 1 (Comparative XL-Dispersion, Yellow)

A 3 L round bottom reactor was loaded with 1945 g of Dispersion 3 (11.19% pigment, Sunbrite Yellow 74, 272-5147 dispersed with Dispersant 2 at P/D 2) and 473.28 g de-ionized water. After mixing the diluted pigment dispersion for several minutes, 5.84 g Denacol 321 epoxy was added, and then the reaction mixture was heated to 80° C. for a total of 6 h. During this time, the acid number decreased from 2.807 to 1.369 mg KOH/g, and pH increased from 7.56 to 7.96. The final dispersion has a surface tension and viscosity of 56.71 dynes/cm and 2.07 cP, respectively, with total solids of 12.93%.

### Final Ultrafiltration Step

The final step in the dispersion process included the final ultrafiltration step which served two purposes. The first purpose was to further remove contaminants, co-solvents and free polymer and the second is to concentrate the dispersion to an acceptable level for use in inkjet ink formulations. For the Magenta dispersion, the final % Pigment concentration that was achieved after ultrafiltration was 12.24%.

### Testing of Redispersability

Testing solutions were made by placing the cross-linked pigment dispersion, water and the disaccharide powder (trehalose or sucrose) into a beaker with magnetic stirrer. The pH of the testing solution was adjusted to 8.00-9.00 by using a TRIZMA solution. After thorough mixing the final testing solution was filtered through a 1 micron paper filter. The following is the testing protocol:
1) Dispense 12 microliters of testing solution in the cavity of a slide glass
2) Place slide glass in a chamber at 60° C. for 18 hours. Once removed from the chamber, the dry sample has a button like appearance in the center of the cavity. The dry residue appears either as a single round piece or fractured into multiple slices.
3) Remove the glass slide and add 60 to 100 microliters of D water on top of the dry sample.
4) Shake the slide in circular motion to promote dissolution of the solid for 1-2 minutes.
5) Place a cover glass on the cavity and inspect c residue with the microscope at 200×.

### Rating of Results

1. Solid is clearly insoluble and water surrounding solid is clear
2. Liquid surrounding the solid has a vivid color (cyan, magenta, yellow black) indicating that solid has dissolved but pieces of solid occupy a large fraction of the optical field.
3. The same as 2, except (ha -dissolved pieces are very small in relationship to the optical field.
4. The solid has totally dissolved and the liquid has the initial color of the dispersion (cyan, yellow, magenta, black).

Magenta dispersions M-1 through M-3 were prepared by mixing Dispersion 1 and trehalose in water. A control dispersion M was also prepared without any trehalose As shown in Table 1 below, Dispersions M1 through M-3 showed improved redispersability compared to Dispersion M.

TABLE 1

| Dispersion | Control M | M-1 | M-2 | M-3 |
|---|---|---|---|---|
| Dispersion 1* | 9.5 | 9.5 | 9.5 | 9.5 |
| Trehalose* | 0 | 8.6 | 11.4 | 14.3 |

| | |
|---|---|
| DI Water | Balance to 100% |

| | | | | |
|---|---|---|---|---|
| REDISPERSABILITY\hat{ } | 2 | 4 | 4 | 4 |

Note:
*% by weight based on the total weight of the dispersion
\hat{ }rating as defined above

Cyan dispersions C-1 through C-3 were prepared by mixing Dispersion 2 and trehalose in water. A control dispersion C was also prepared without any trehalose. As shown in Table 2 below, Dispersions C1 through C-3 showed improved redispersability compared to Dispersion C.

TABLE 2

| Dispersion | Control C | C-1 | C-2 | C-3 |
|---|---|---|---|---|
| Dispersion 2* | 12 | 12 | 12 | 12 |
| Trehalose* | 0 | 14 | 18 | 21.6 |

| | |
|---|---|
| DI Water | Balance to 100% |

| | | | | |
|---|---|---|---|---|
| REDISPERSABILITY\hat{ } | 1 | 2 | 3 | 4 |

Note:
*% by weight based on the total weight of the dispersion
\hat{ }rating as defined above

Yellow dispersions Y-1 through Y-4 were prepared by mixing Dispersion 3 and trehalose or sucrose in water. A control dispersion Y was also prepared without any trehalose or sucrose. As shown in Table 3 below, Dispersion Y-1 showed improved redispersability compared to Dispersion Y. However, comparative Dispersions Y-2 through Y-4 also showed modest amount of improvement to redispersability.

TABLE 3

| | Dispersion | | | | |
|---|---|---|---|---|---|
| | Control | | Y-2 | Y-3 | Y-4 |
| | Y | Y-1 | (comp.) | (Comp.) | (Comp.) |
| Dispersion 1* | 7.26 | 7.26 | — | — | — |
| Comparative | — | — | 7.26 | 7.26 | 7.26 |
| Dispersion 1 | | | | | |
| Trehalose* | 0 | 14 | 0 | 0 | 0 |
| Sucrose* | 0 | 0 | 7 | 10 | 14 |
| REDISPERSABILITY\hat{ } | 2 | 3 | 2 | 2 | 4 |

Note:
*% by weight based on the total weight of the dispersion
\hat{ }rating as defined above

Each dispersion was also tested for particle size, pH, conductivity, viscosity and solids. The results for the Pigment Dispersion 1 (Magenta) are shown in the table below. The results in Stage 2 show the final properties of the dispersion after x-linking, ultrafiltration and trehelose addition. Included in the table are the dispersion stability results after one week in the oven at 70° C. Dispersion stability is deemed important to demonstrating the utility of the dispersion in making a stable ink with desired printing performance properties.

Dispersion Properties for Pigment Dispersion 1 (Magenta) with Trehelose

| | Particle Size | | | | Cond. | Visc | | |
|---|---|---|---|---|---|---|---|---|
| | D50 | D95 | % < 204 | pH | (ms) | (cps) | % Solids | % Pigment |
| Pigment Dispersion 1 (Magenta) | 101.30 | 197.00 | 96.05 | 7.47 | 4.21 | 12.70 | 19.53 | 12.68 |
| Stage 1 (premix/media Mill) | | | | | | | | |
| Pigment Dispersion 1 (Magenta) | 112.90 | 192.80 | 96.53 | 8.63 | 2.64 | 72.10 | 29.26 | 12.24 |
| Stage 2 (X-linking/Trehelose) | | | | | | | | |
| 1 week Oven Stability, Pigment | 108.30 | 199.20 | 95.72 | 8.51 | 2.82 | 37.40 | 29.26 | 12.24 |
| Dispersion 1 (Magenta) Stage 2 | | | | | | | | |
| (X-linking/Trehelose) | | | | | | | | |

Dispersion Properties for Pigment Dispersion 2 (Cyan) with Trehelose

| | Particle Size | | | | Cond. | Visc | | |
|---|---|---|---|---|---|---|---|---|
| | D50 | D95 | % < 204 | pH | (ms) | (cps) | % Solids | % Pigment |
| Pigment Dispersion 2 (Cyan) | 125.20 | 275.50 | 83.45 | 7.24 | 3.32 | 6.98 | 16.46 | 11.17 |
| Stage 1 (premix/ media Mill) | | | | | | | | |
| Pigment Dispersion 2 (Cyan) | 123.00 | 224.00 | 91.76 | 8.07 | 3.77 | 60.90 | 23.53 | 16.85 |
| Stage 2 (X-linking/Trehelose) | | | | | | | | |
| 1 week Oven Stability, | 117.60 | 246.30 | 90.10 | 8.03 | 4.00 | 40.10 | 23.53 | 16.85 |
| Dispersion 2 (Cyan) Stage 2 | | | | | | | | |
| (X-linking/Trehelose) | | | | | | | | |

Dispersion Properties for Pigment Dispersion 3 (Yellow) with Trehelose

| | Particle Size | | | | Cond. | Visc | | |
|---|---|---|---|---|---|---|---|---|
| | D50 | D95 | % < 204 | pH | (ms) | (cps) | % Solids | % Pigment |
| Pigment Dispersion 3 (Yellow) | 91.50 | 202.00 | 95.26 | 7.69 | 1.82 | 3.60 | 17.55 | 11.56 |
| Stage 1 (premix/ media Mill) | | | | | | | | |
| Pigment Dispersion 3 (Yellow) | 77.10 | 200.60 | 95.53 | 7.84 | 1.84 | 5.28 | 21.57 | 14.79 |
| Stage 2 (X-linking/Trehelose) | | | | | | | | |
| 1 week Oven Stability, Pigment | 86.40 | 203.10 | 95.16 | 7.63 | 1.93 | 4.55 | 21.57 | 14.79 |
| Dispersion 3 (Yellow) Stage 2 | | | | | | | | |
| (X-linking/Trehelose) | | | | | | | | |

### Comparative Example 1

### Crosslinked Yellow Dispersion with Sucrose

| | Particle Size | | | | Cond. | Visc | | |
|---|---|---|---|---|---|---|---|---|
| | D50 | D95 | % < 204 | pH | (ms) | (cps) | % Solids | % Pigment |
| Pigment Dispersion 3 (Yellow) | 91.50 | 202.00 | 95.26 | 7.69 | 1.82 | 3.60 | 17.55 | 11.56 |
| Stage 1 (premix/media Mill) | | | | | | | | |
| Pigment Dispersion 3 (Yellow) | 91.70 | 204.40 | 95.00 | 7.85 | 1.88 | 5.51 | 21.99 | 14.66 |
| Stage 2 (X-linking/Trehelose) | | | | | | | | |
| 1 week Oven Stability, Pigment | 99.30 | 192.60 | 96.38 | 8.05 | 1.97 | 4.84 | 21.57 | 14.79 |
| Dispersion 3 (Yellow) Stage 2 | | | | | | | | |
| (X-linking/Trehelose) | | | | | | | | |

What is claimed is:

1. An ink-jet ink comprising an aqueous vehicle and an aqueous pigment dispersion, wherein said pigment dispersion is comprised of a colorant, a polyacrylate dispersant to disperse said colorant and a disaccharide, wherein said dispersion can be concentrated to having greater than 60% of said colorant by weight based on the weight of the dispersion and rehydrated with water to reconstitute said dispersion.

2. The ink of claim 1, wherein said dispersion can be concentrated to having greater than 65% of said colorant by weight based on the weight of the dispersion and rehydrated with water to reconstitute said dispersion.

3. The ink of claim 2, wherein said dispersion can be concentrated to having greater than 70% of said colorant by weight based on the weight of the dispersion and rehydrated with water to reconstitute said dispersion.

4. The ink of claim 1, wherein said dispersion can be concentrated to having greater than 60% of said colorant by weight based on the weight of the dispersion and rehydrated with water with a growth in particle size of less than 10%.

5. The ink of claim 4, wherein said polyacrylate dispersant is a polymer containing an aqueous dispersing moiety and a cross-linkable moiety that is cross-linked with a cross-linking agent.

6. The ink of claim 5, wherein said aqueous dispersing moiety is a carboxyl group.

7. The ink of claim 6, wherein said a cross-linkable moiety moiety is a carboxyl group.

8. The ink of claim 7, wherein said cross-linking agent is one or more members selected from the group consisting of epoxide, isocyanate, carbodiimide, N-methylol, oxazoline, silane, and mixtures thereof.

9. The ink of claim 8, wherein said cross-linking agent is epoxide.

10. The ink of claim 9, wherein said disaccharide is trehalose.

11. The ink of claim 1, wherein said dispersion can be concentrated to having greater than 60% of said colorant by weight based on the weight of the dispersion and rehydrated with water with a growth in particle size of less than 5%.

12. The ink of claim 11, wherein said polyacrylate dispersant is a polymer containing an aqueous dispersing moiety and a cross-linkable moiety that is cross-linked with a cross-linking agent.

13. The ink of claim 12, wherein said aqueous dispersing moiety is a carboxyl group.

14. The ink of claim 13, wherein said a cross-linkable moiety moiety is a carboxyl group.

15. The ink of claim 14, wherein said cross-linking agent is one or more members selected from the group consisting of epoxide, isocyanate, carbodiimide, N-methylol, oxazoline, silane, and mixtures thereof.

16. The ink of claim 15, wherein said cross-linking agent is epoxide.

17. The ink of claim 16, wherein said disaccharide is trehalose.
